(19) United States
(12) Patent Application Publication
(10) Pub. No.: US 2020/0320016 A1
(43) Pub. Date: Oct. 8, 2020

(54) METHOD ENABLING VIRTUAL PAGES TO BE ALLOCATED WITH NONCONTIGUOUS BACKING PHYSICAL SUBPAGES

(71) Applicant: Advanced Micro Devices, Inc., Santa Clara, CA (US)

(72) Inventor: Alexander D. Breslow, Santa Clara, CA (US)

(21) Appl. No.: 16/378,479

(22) Filed: Apr. 8, 2019

(51) Int. Cl. G06F 12/1027; G06F 12/1009

(52) U.S. Cl. CPC G06F 12/1027; G06F 2212/684; G06F 12/1009

(57) ABSTRACT

A device includes an address translation buffer to, for each virtual page number of a plurality of virtual page numbers, store a mapping associated with the virtual page number. The mapping identifies a set of physical subpages allocated for the virtual page number, and the set of physical subpages includes at least a first physical subpage of a plurality of contiguous subpages in a physical memory region and excludes at least a second physical subpage of the plurality of contiguous subpages in the physical memory region. A memory management unit is coupled with the address translation buffer to, in response to receiving a requested virtual subpage number and a requested virtual page number of the plurality of virtual page numbers, determine, based on the mapping associated with the requested virtual page number, a physical subpage number identifying a physical subpage that is allocated for the requested virtual subpage number.

### BACKGROUND

Memory virtualization is a technique employed in modern computing systems that allows software processes to view non-contiguous physical memory regions as a single contiguous region. A software process or task executing in the computer accesses memory using virtual memory addresses; these are mapped to physical memory addresses, and the translation between virtual and physical memory addresses is handled by hardware and software in the computer. The operating system in the computer handles the assignment of physical memory to virtual memory, and translations between virtual and physical memory addresses are performed automatically by a memory management unit (MMU).

Virtualization of memory allows processes to be run in their own dedicated virtual address spaces, obviating the need to relocate program code or to access memory with relative addressing, and also increasing security due to memory isolation. In addition, systems using virtual memory addressing methods delegate to the kernel the burden of managing the memory hierarchy, and make application programming easier by hiding fragmentation of physical memory.

### BRIEF DESCRIPTION OF THE DRAWINGS

The present disclosure is illustrated by way of example, and not by way of limitation, in the figures of the accompanying drawings.

FIG. 1 illustrates a fragmented region of physical memory, according to an embodiment.

FIG. 2 illustrates a computing system, according to an embodiment.

FIG. 3 illustrates components in a processing unit and a main memory in a computing device, according to an embodiment.

FIG. 4 illustrates a page table walk for translating a virtual address, according to an embodiment.

FIGS. 5A and 5B illustrate the SELECT and RANK operations, according to an embodiment.

FIGS. 6A, 6B, and 6C each illustrate a translation of a virtual memory address using a translation lookaside buffer (TLB), according to an embodiment.

FIG. 7 illustrates contiguous and fragmented free lists, according to an embodiment.

FIG. 8 illustrates the allocation of memory using the SELECT function, according to an embodiment.

FIG. 9 is a flow diagram illustrating a memory allocation and deallocation process, according to an embodiment.

FIG. 10 is a flow diagram illustrating a process for accessing memory, according to an embodiment.

### DETAILED DESCRIPTION

The following description sets forth numerous specific details such as examples of specific systems, components, methods, and so forth, in order to provide a good understanding of the embodiments. It will be apparent to one skilled in the art, however, that at least some embodiments may be practiced without these specific details. In other instances, well-known components or methods are not described in detail or are presented in a simple block diagram format in order to avoid unnecessarily obscuring the embodiments. Thus, the specific details set forth are merely exemplary. Particular implementations may vary from these exemplary details and still be contemplated to be within the scope of the embodiments.

Modern computing systems implementing virtual memory addressing can concurrently use multiple different memory page sizes (e.g., 4 KB, 2 MB, and 1 GB). A result of this design decision is that systems whose memory is mostly subscribed tend to make memory allocations that lead to increased memory fragmentation, which makes allocation of larger memory regions difficult unless costly and frequent defragmentation of the memory is performed. As memory becomes fragmented due to one or more co-running applications consuming the bulk of the available physical memory, it becomes increasingly difficult to allocate superpages (i.e., the larger of the supported page sizes) due to memory fragmentation.

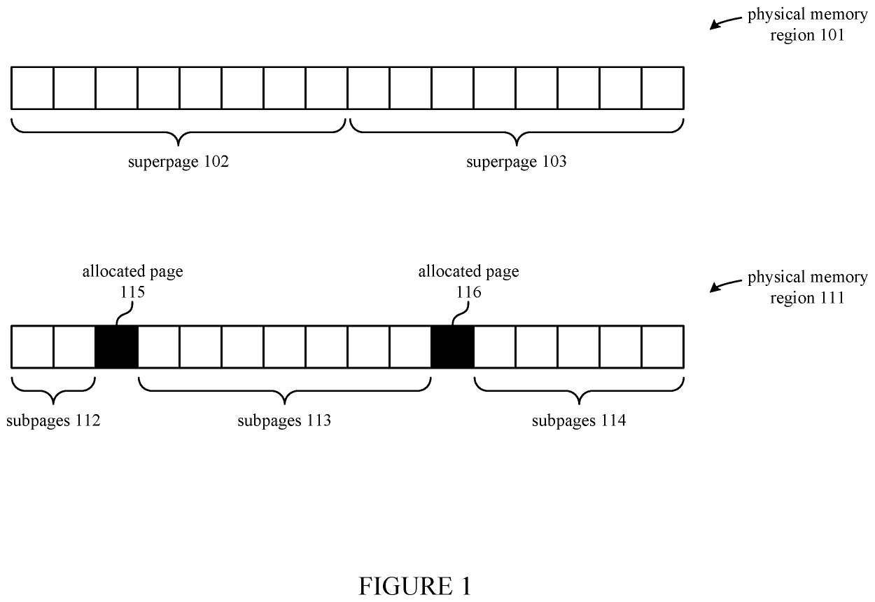

FIG. 1 illustrates physical memory regions 101 and 111, according to an embodiment. Each of the memory regions 101 and 111 includes 16 physical pages in a system supporting a superpage size of 8 pages. The 16-page physical memory region 101 can be allocated to a maximum of two 8-page superpages 102 and 103, since none of the subpages in region 101 have been allocated. In physical memory region 111, the unallocated space is fragmented by two pages 115 and 116 that have already been allocated for other data. Physical memory region 111 has sufficient total capacity in subpages 112-114 for allocating an 8-page superpage; however, none of the sets of contiguous free subpages 112-114 is large enough to be allocated for the superpage.

In one embodiment, a computing system implementing virtual memory addressing includes a page table, which contains entries for translating virtual memory addresses to their corresponding physical memory addresses, and a translation lookaside buffer (TLB), which caches the page table entries. The entries in the page table and TLB additionally encode, for each virtual page number that can be specified in a virtual address, a mapping indicating which subpages in the backing physical memory region are allocated for the virtual page number. In some embodiments, the mapping can be stored as a bit vector that has an asserted bit for each subpage in the physical memory page that is allocated for backing the virtual page number, and/or as precomputed pairs of virtual subpage numbers and their corresponding physical subpage numbers. A request to translate a virtual address (which includes a virtual page number and a virtual subpage number) proceeds by identifying a physical region number and a mapping corresponding to the virtual page number, then using the mapping to determine a physical subpage number in the physical region that corresponds to the virtual subpage number.

The mapping stored in the page table and TLB entries allows defragmentation to be stayed or delayed by providing a mechanism for a large virtual superpage to be backed by smaller non-contiguous physical subpages. The operating system is able to batch memory defragmentation to periods where the computing system has low system load, when the defragmentation operation is less likely to affect user application performance. In addition, large segments of virtual memory can be more easily allocated in near-contiguous physical pages even at heavy memory loads. In addition, the page table depth is reduced, since a given amount of memory can be addressed by a single virtual superpage rather than multiple smaller pages. Because the virtual page size is larger for an equivalent physical page size, a page table walk traverses fewer levels of the page table. Most address translation cache misses in the memory management unit (MMU) and input/output memory management unit (IOMMU) occur at the leaf node level of the page table; therefore, skipping this level can have a large impact on performance, particularly in virtualized environments with nested page table walks and on graphics processing units (GPUs) where contention is high.

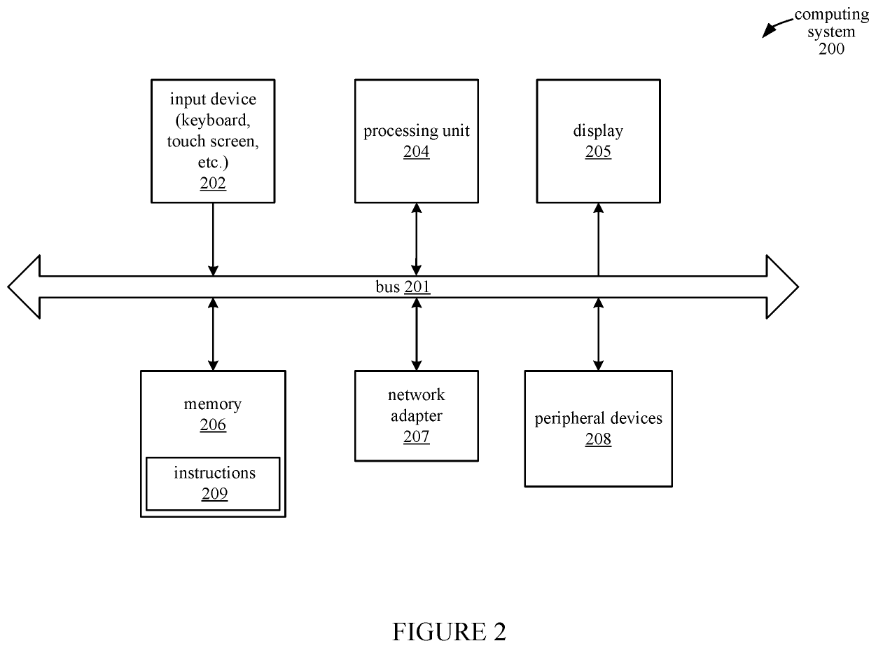

FIG. 2 illustrates an embodiment of a computing system 200 which that implements the above mapping technique. In general, the computing system 200 may be embodied as any of a number of different types of devices, including but not limited to a laptop or desktop computer, mobile phone, server, etc. The computing system 200 includes a number of components 202-208 that can communicate with each other through a bus 201. In computing system 200, each of the components 202-208 is capable of communicating with any of the other components 202-208 either directly through the bus 201, or via one or more of the other components 202-208. The components 201-208 in computing system 200 are contained within a single physical casing, such as a laptop or desktop chassis, or a mobile phone casing. In alternative embodiments, some of the components of computing system 200 may be embodied as peripheral devices such that the entire computing system 200 does not reside within a single physical casing.

The computing system 200 also includes user interface devices for receiving information from or providing information to a user. Specifically, the computing system 200 includes an input device 202, such as a keyboard, mouse, touch-screen, or other device for receiving information from the user. The computing system 200 displays information to the user via a display 205, such as a monitor, light-emitting diode (LED) display, liquid crystal display, or other output device.

Computing system 200 additionally may include a network adapter 207 for transmitting and receiving data over a wired or wireless network. Computing system 200 also includes one or more peripheral devices 208. The peripheral devices 208 may include mass storage devices, location detection devices, sensors, input devices, or other types of devices that can be used by the computing system 200.

Computing system 200 includes a processing unit 204 that receives and executes instructions 209 that are stored in the main memory 206. As referenced herein, processing unit 204 represents a central processing unit (CPU) pipelines, graphics processing unit (GPU), or other computing engine that supports memory operations that use virtual addresses. Main memory 206 may be part of a memory subsystem of the computing system 200 that includes memory devices used by the computing system 200, such as random-access memory (RAM) modules, read-only memory (ROM) modules, hard disks, and other non-transitory computer-readable media.

In addition to the main memory 206, the memory subsystem may also include cache memories, such as L2 or L3 caches, and/or registers. Such cache memory and registers may be present in the processing unit 204 or on other components of the computing system 200.

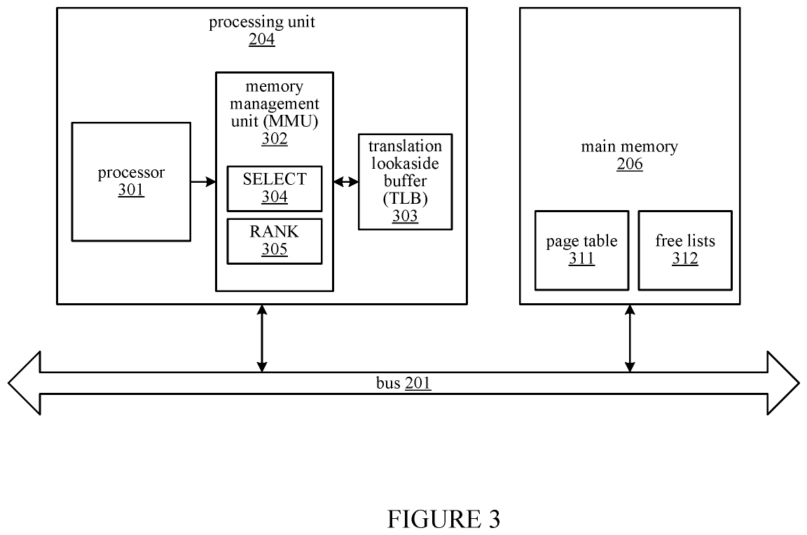

FIG. 3 illustrates the processing unit 204 and main memory 206 of the computing system 200, according to an embodiment. The processing unit 204 includes a processor 301 (e.g., a CPU, GPU, etc.), a memory management unit (MMU) 302, and a translation lookaside buffer (TLB) 303. In one embodiment, the components 301, 302, and 303 of the processing unit 204 are contained within the same device package. During execution of program instructions 209, the processor 301 accesses data stored in the main memory 206 by issuing memory requests via one or more memory controllers. The processor 301 references memory locations using virtual addresses, which are translated to physical memory addresses by the MMU 302. The MMU 302 performs the translations using entries in the page table 311, which stores the virtual address to physical address translations. The translations are additionally cached in the TLB. In one embodiment, the MMU 302 also includes SELECT 304 and RANK circuitry 305, which are used for decoding mappings (e.g., bit vectors, sets of precomputed physical addresses, etc.) stored in the page table 311 and/or the TLB 303.

The page table 311 is stored in the main memory 206 and stores address translation information in a tree, hash table, or associative map data structure. The processing unit 204, upon accessing a virtual address, performs a virtual-to-physical address translation by checking the TLB 303 for the translation and, if the translation is not available in the TLB 303 (i.e., a TLB miss occurs), then the MMU 302 performs a page table walk. During the page table walk, the MMU 302 traverses the nodes in the page table 311 based on the virtual address to be translated. In the page table 311, interior nodes are nodes that contain entries each pointing to a child node in the page table 311. Leaf nodes in the page table 311 contain entries that point to physical pages of application data in the physical memory. What constitutes a leaf node changes with the page size (e.g., L3, L2, or L1 in x86_64 long mode with 1 GB, 2 MB, and 4 KB pages, respectively) as more of the virtual address is page offset with larger pages.

The memory 206 also stores a set of free lists 312. Free lists 312 are maintained by the operating system of the computing system 200 and are used to keep track of memory pages that are available for allocating to new data. As memory is deallocated (i.e., freed), the deallocated pages are added to one of the free lists 312. When memory is allocated, free memory pages for allocating the new data are identified from the free lists 312.

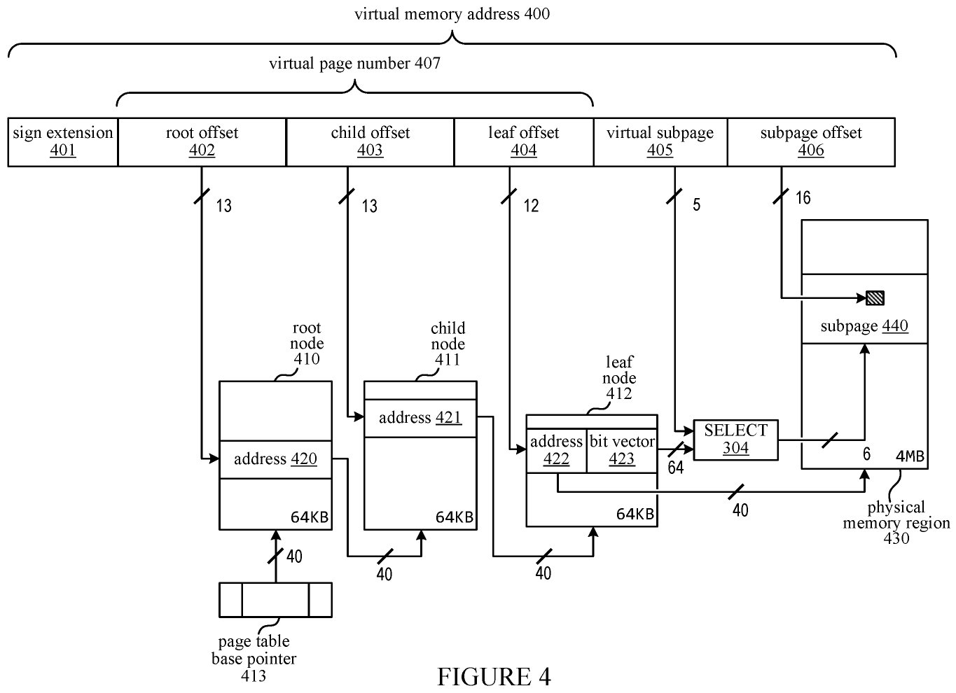

FIG. 4 illustrates translation of a virtual memory address into a physical memory address using the page table 311, according to an embodiment. The virtual memory address 400 includes a sign extension 401, a virtual page number 407 (including root offset 402, child offset 403, and leaf offset 404), a virtual subpage 405, and a subpage offset 406. The fields 402-406 in the virtual memory address 400 are used to traverse nodes in the page table 311, including the root node 410, child node 411, and leaf node 412.

The entries in the page table 311 permit allocating a set of partially or fully disjoint (i.e., noncontiguous) physical subpages from a large physical memory region to back a smaller virtual superpage. In one embodiment, the physical memory region is twice the size of the virtual superpage it backs, while virtual and physical subpages are the same size. Therefore, the physical memory region includes twice as many subpages as its corresponding virtual superpage. Accordingly, if at least half of the physical subpages in the physical region are free, then the free physical subpages can be used to back a virtual superpage.

Each page table entry is recorded in the page table 311 as a number of address fields (e.g., 420-422). In one embodiment, the address fields also include additional metadata or unassigned bits that the operating system or MMU 302 can manipulate. In one embodiment, each page table entry includes a mapping (e.g., a bit vector 423) that identifies which of the physical subpages in the larger physical memory region are allocated to store the contents of the virtual page. In the exemplary address translation as illustrated in FIG. 4, a 2 MB virtual page size is backed by 64 KB physical subpages. Each page table entry (e.g., leaf node 412) has an embedded 64-bit bit vector (e.g., bit vector 423), that includes one bit for each physical subpage indicating whether the physical subpage backs one of the 32 virtual subpages in the 2 MB virtual page. Each virtual subpage represents 1/32 of the virtual address spaces spanned by the 2 MB virtual page, or 64 KB worth of memory capacity. In other words, the bit vector 423 identifies which of the 64 64-KB physical subpages in the backing physical memory region are used to back the 2 MB virtual page. Thus, the bit vector tracks 64×64 KB, or 4 MB, of physical memory in the backing physical region. If the backing physical memory region has at least 2 MB of physical memory that is free (i.e., at least 32 64-KB subpages worth), then the physical memory region can be allocated for backing a 2 MB virtual page. For each physical subpage of the 4 MB backing physical region, the corresponding bit in the bit vector 423 is asserted if the physical subpage is allocated for the virtual page. In one embodiment, the bit is asserted high (e.g., set to ‘1’) and deasserted low (e.g., set to ‘0’). In other embodiments, other values or electrical states can be used to represent asserted and deasserted states (e.g., asserted low and deasserted high). The address field 422 of the leaf entry is set to point to the zeroth byte of the 4 MB physical memory region. In one embodiment, the address fields (e.g., 420-422) are stored as physical page numbers that are left shifted by the base 2 logarithm of the size, in bytes, of the memory block to which they point (e.g., 16 for 64 KB, or 22 for 4 MB). For example, the address field 422 stores a physical region identifier that is left shifted by the base 2 logarithm of 4×1024×1024 (i.e., 22) to calculate the zeroth byte of the 4 MB physical region.

For the translation of virtual memory address 400, a page table base pointer 413 (e.g., stored in a control register in x86 systems) points to the root node 410 of the page table 311, then the root offset 402 is used to select the address 420 from the root node 410. Address 420 points to the child node 411, from which the child offset 403 is used to select the address 421. Address 421 points to the leaf node 412, and the leaf offset 404 is used to select the address 422. Address 422 is additionally associated with a bit vector 423 also stored in the leaf node 412. The address field 422 of the leaf node 412 points to the zeroth byte of a 4 MB physical memory region, while the bit vector 423 identifies the (possibly noncontiguous) physical subpages in the indicated physical memory region that are allocated for backing the virtual page.

In the virtual memory address 400, the virtual subpage field 405 includes 5 bits (representing a value from 0 to 31) for identifying one of the 32 virtual subpages in the virtual page. To determine which physical subpage backs the specified virtual subpage 405, a SELECT operation on the bit vector 423 is performed by a SELECT circuit 304.

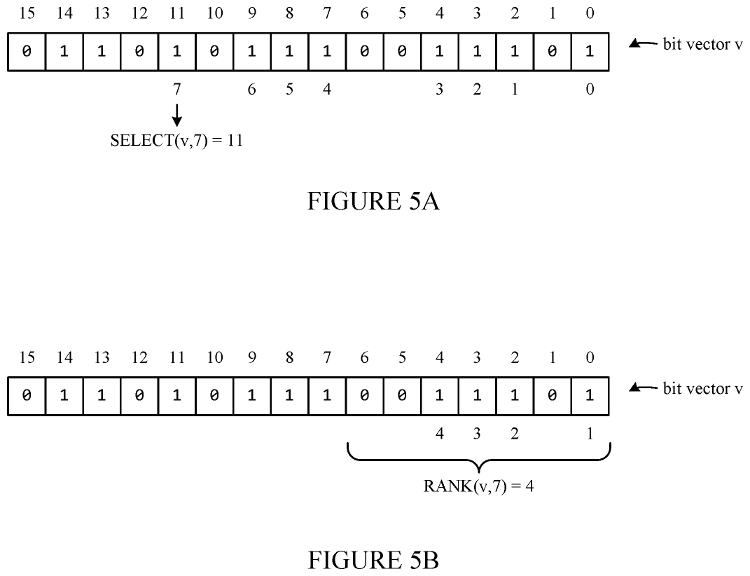

FIG. 5A illustrates the operation of the SELECT function, according to an embodiment. Given a bit vector v and an index i, the SELECT function returns the index of the ith least significant bit that is set to ‘1’ when counting from zero. In the example illustrated in FIG. 5A, the SELECT function is provided with 16-bit vector v and an input index of ‘7’. The SELECT function counts the ‘1’ bits from the least significant end of the bit vector v from 0 to the input index ‘7’ (i.e., counting to the 8^{th} ‘1’ bit in the bit vector v). The 8^{th} ‘1’ bit is at position ‘11’ in the bit vector v. Thus, SELECT(v, 7) returns ‘11’. As an additional example, SELECT(0b10101010, 3) returns ‘7’ since the fourth ‘1’ bit (since parameter ‘3’ is zero-indexed) occurs at bit position 7 in the vector. Using the same input bit vector, SELECT(0b10101010, 0) would return ‘1’ since the first ‘1’ bit occurs at index 1.

The SELECT circuit 304 performs the SELECT function with bit vector 423 as the input bit vector v and the 5 bits of the virtual subpage number 405 as the input index, and outputs the index of the physical subpage 440 within the 4 MB physical memory region 430. The calculated physical subpage index is left shifted to calculate the full physical address of the zeroth byte of the physical subpage. In the given example with 64 KB subpages, the calculated physical subpage index is left shifted by 16. The 16 bits of subpage offset 406 are used as a byte-level index into the physical subpage 440. In the foregoing address translation example, the sizes of virtual and physical page, physical memory regions, address fields, etc. are exemplary, and different parameters are possible in alternative embodiments.

FIG. 5B illustrates the operation of a RANK function, which is a companion function of SELECT, according to an embodiment. In one embodiment, the RANK function is executed by the RANK circuit 305 that, when given a bit vector v and an input index i, returns the number of bits prior to index i in the bit vector v that are set to ‘1’. In the example illustrated in FIG. 5B, the RANK function returns ‘4’ for an input bit vector v and an input index of ‘7’ because 4 bits are set to ‘1’ prior to bit position 7 in the bit vector v. Thus, the RANK function is used to determine how many physical subpages are allocated or free, as indicated by a bit vector v (e.g., when allocating or deallocating memory).

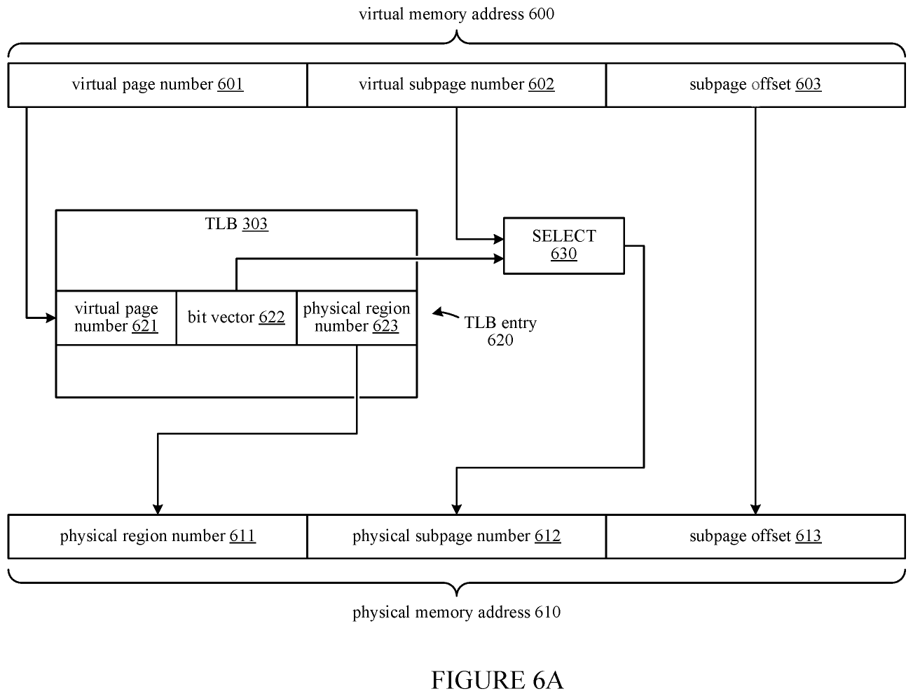

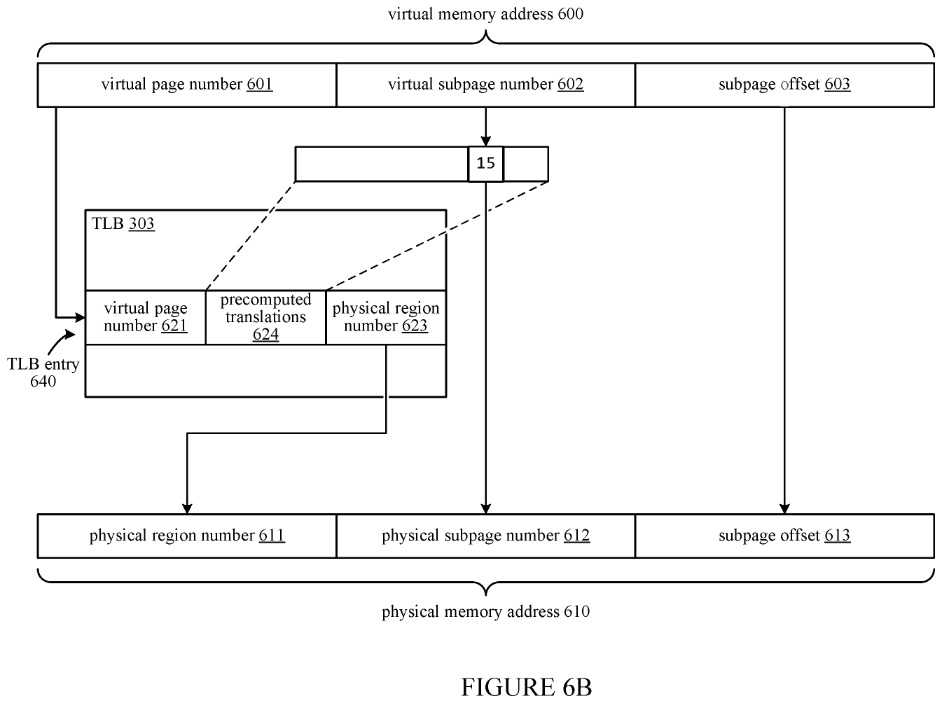

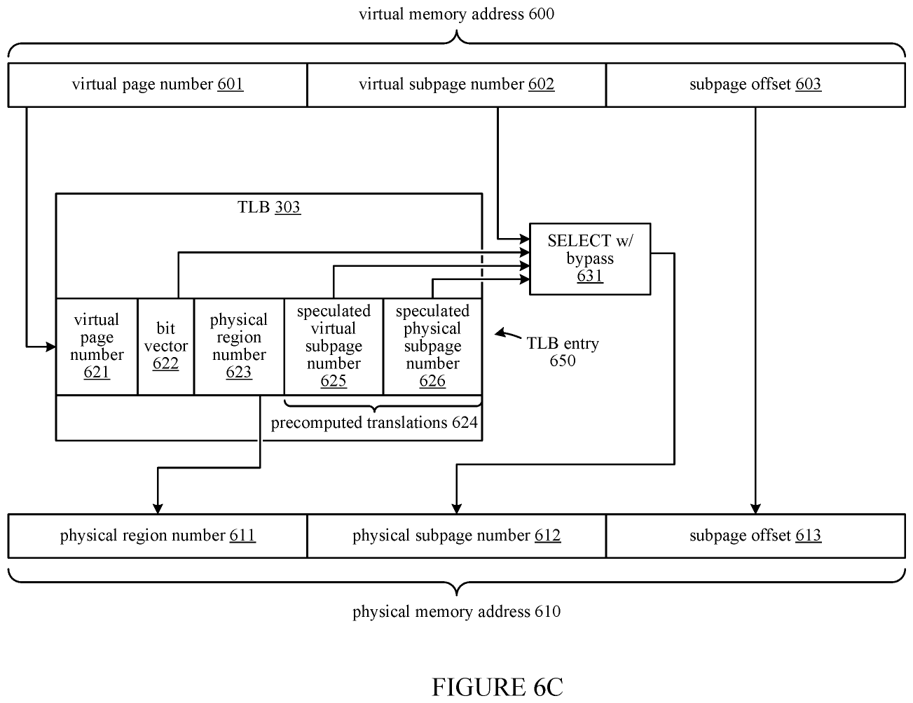

FIG. 6A illustrates an embodiment of a TLB 303 in which mappings are stored to identify, for each virtual memory page of a number of virtual memory pages, which noncontiguous physical subpages of a physical memory region are allocated for the virtual memory page, according to an embodiment. The TLB 303 is a buffer used for address translation that caches entries from the page table 311 and, for at least a subset of entries, includes a mapping from the associated leaf node (e.g., node 412) of the page table 311. As illustrated in FIG. 6A, an entry 620 in the TLB 303 associates a virtual page number 621 with a mapping (i.e., bit vector 622) and a physical region number 623. Continuing the previous example, the physical region number 623 identifies a 4 MB physical memory region (including a set of contiguous physical subpages) that backs the 2 MB virtual page identified by the virtual page number 621.

The bit vector 622 identifies which of the physical subpages in the backing physical memory region are allocated for the virtual page. The bit vector includes an asserted bit for each of the physical subpages that is allocated for the virtual page, and a deasserted bit for each free subpage in the backing physical memory region that is not allocated for the virtual page number. In one embodiment, the bits in the bit vector 622 are arranged in the same order as their corresponding physical subpages are ordered in the physical memory region.

When the MMU 302 receives a virtual memory address 600 to be translated to a physical memory address 610, the MMU 302 uses the virtual page number 601 in the virtual memory address 600 to perform a lookup in the TLB 303. A TLB hit occurs when a matching virtual page number 621 is found in the TLB 303. The virtual page number 621 is associated with a bit vector 622 and a physical region number 623 in the TLB entry 620. When the TLB hit occurs, the physical region number 623 becomes the most significant bits 611 of the physical memory address 610. The bit vector 622 from the TLB entry 620 and the virtual subpage number 602 serve as the inputs to a SELECT circuit 630 connected to the TLB 303.

The SELECT circuit 630 determines the physical subpage number 612 by calculating an index of an ith least significant asserted bit in the bit vector 622, where i represents the requested virtual subpage number 602. The SELECT circuit 630 outputs the physical subpage number 612 to the middle of the physical address 610. The calculated physical subpage number 612 and the physical region number 611 (which is common to all subpages backing the virtual page) form the physical address of the physical subpage. The remaining subpage offset bits 613 in the physical memory address 610 are the same as the subpage offset bits 603 in the virtual memory address 600. In alternative embodiments, these fields may be permuted or split over non-contiguous bits. Further, virtual and physical subpages do not necessarily have to be the same size.

FIG. 6B illustrates an embodiment of a TLB 303 in which a mapping for each virtual page number is stored as a set of precomputed translations 624. Each of the precomputed translations 624 associates a precomputed virtual subpage number with a precomputed physical subpage number. In one embodiment, the precomputed physical subpage numbers are stored in an array of precomputed translations 624, where each precomputed physical subpage number is stored at an index in the array 624 corresponding to its associated virtual subpage number.

In one embodiment having the same parameters as the previous example, a full set of translations of virtual subpage numbers to physical subpage numbers for a 2 MB superpage is stored in 32 6-bit counters. When a virtual memory address 600 is translated to a physical memory address 610, the virtual page number 601 is used to lookup the TLB entry 640. Once the TLB entry 640 is located (i.e., a TLB hit occurs), the TLB 303 uses the virtual subpage number 602 to index into the precomputed translation field 624 containing the precomputed physical subpage numbers. As illustrated in FIG. 6B, the physical subpage number ‘15’ is stored at the array index indicated by the virtual subpage number 602; thus ‘15’ becomes the physical subpage number 612 in the physical memory address 610. The subpage offset 613 in the physical memory address 610 is the same as the subpage offset 603 in the virtual memory address 600.

In one embodiment, the SELECT operation is performed once in bulk to precompute the translations for all of the virtual subpages in the virtual page 621 at or prior to installing the TLB entry 640 in the TLB. Thus, the SELECT operation need not be performed for each translation, and a SELECT circuit is not included with the TLB 303 itself.

FIG. 6C illustrates an embodiment of a TLB 303 that, in each entry, stores the mapping for a virtual page as a bit vector (e.g., 622), and additionally stores precomputed translations for a subset of the virtual subpage numbers in the virtual page (e.g., 625 and 626) in the precomputed translations field 624. In one embodiment, the TLB 303 speculates to identify one or more virtual subpages that are likely to be translated in the future and precomputes the translations for these virtual subpages to their respective physical subpages.

In one embodiment, the most recently accessed virtual subpage number is selected as the speculated virtual subpage number 625 and stored along with its precomputed speculated physical subpage number 626. In one embodiment, a small history of the recently observed virtual subpage numbers and their corresponding physical subpages is stored. The history of virtual subpage translations is used to predict which virtual subpages are likely to be translated next by, for example, deducing access stride information from the history. The next one or more expected virtual subpage numbers and their accompanying physical subpage numbers are then precomputed and stored in the TLB 303.

If a virtual memory address 600 to be translated specifies a virtual subpage number 602 that does not match any of the virtual subpages for which a translation was precomputed (e.g., speculated virtual subpage number 625), the SELECT operation is performed by SELECT circuit 631 to calculate the correct physical subpage number 612 for the requested virtual subpage number 602 based on the bit vector 622 and the requested virtual subpage number 602, as previously described. The SELECT circuit 631 includes bypass circuitry so that if the virtual subpage number 602 does match the speculated virtual subpage number 625, the SELECT circuit 631 bypasses the SELECT operation and instead uses the associated speculated physical subpage number 626 as the physical subpage number 612. FIG. 6C illustrates a TLB 303 that stores a single speculated virtual subpage number 625 and its corresponding precomputed physical subpage number 626 in a single TLB entry 650; however, alternative embodiments can include multiple such speculated translation pairs per TLB entry. In alternative embodiments, the speculated virtual subpage number 625 and speculated physical subpage number 626 are stored in a data structure separate from the TLB 303.

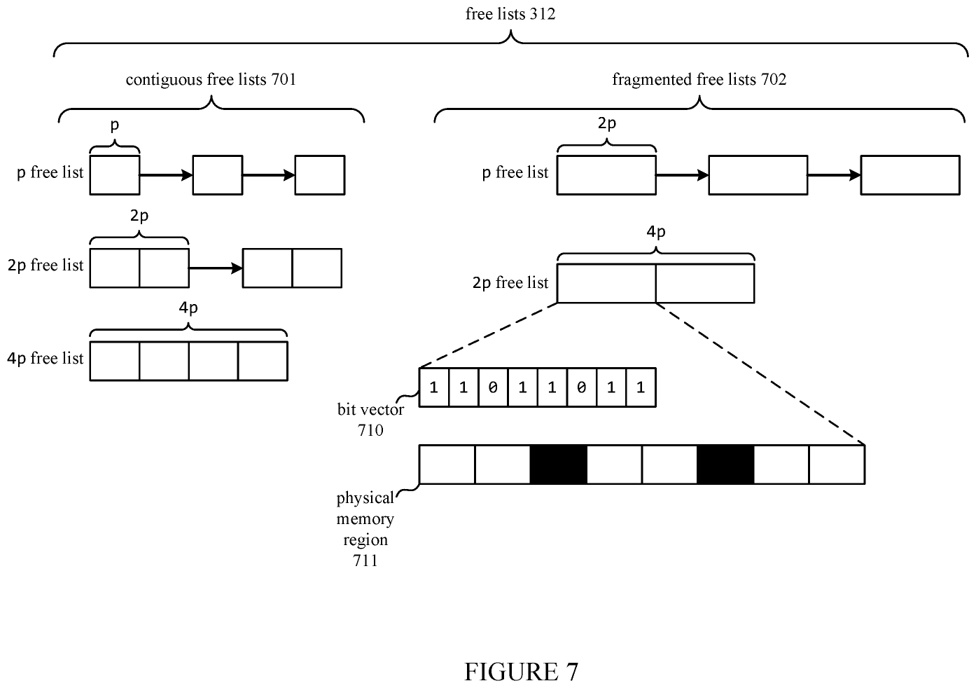

FIG. 7 illustrates a set of free lists 312 for tracking which physical memory pages in the memory 206 are available for allocating for new data, according to an embodiment. The free lists 312 include two sets of free lists: a first set of free lists 701 for defragmented (i.e., contiguous) memory segments, and a second set of free lists 702 for fragmented memory segments. In one embodiment, free lists 312 are maintained by operating system routines executed in the processing unit 204. The operating system maintains multiple free lists in each of the sets 701 and 702. Each of the lists is associated with a different memory size (e.g., p, 2p, 4p, etc.), where p represents the size of a memory page. The p, 2p, and 4p free lists in set 701 are associated with sizes differing by powers of two; that is, each subsequent free list in the set 701 is associated with a memory size that is two times as large as the previous free list. When a request for allocating memory is serviced, the amount of memory requested is rounded up to the nearest size of a physical page times a power of two. A free list corresponding to the determined size is identified, and a free memory region is selected from the free list to complete the allocation.

The operating system places regions of contiguous free memory (i.e., not already allocated for any data) that are available for allocation in one of the free lists 701. Each of the free lists 701 includes a node for each of one or more contiguous memory regions in the free list, and each of the contiguous memory regions in the free list is the size associated with the free list. For example, nodes in the p free list include contiguous free memory regions of size p, nodes in the 2p free list include contiguous free memory regions of size 2p, and so on. When an allocation is performed, a node is removed from the free list associated with a sufficient size for storing the data to be allocated, and the free memory region in the removed node is allocated for the new data. In one embodiment, a buddy allocation system is used to combine adjacent sets of free pages in one free list and move them to the next higher capacity free list (e.g., two adjacent p sized segments are combined and moved from the p free list to the 2p free list).

In one embodiment, the operating system also maintains a second set of free lists 702 for backing memory regions that are already partially allocated (i.e., fragmented). For instance, a 64 MB region of physical memory that is mostly free, except that each 2 MB page of physical memory in the 64 MB region has at least one 64 KB subpage already allocated, does not include any contiguous 2 MB page for allocating to new data. However, this 64 MB physical region can be used for allocating 32 MB of contiguous virtual memory (or several smaller allocation requests) using noncontiguous physical memory if each 4 MB backing physical region is at least half free. The second set of free lists 702 tracks available memory in fragmented memory regions, such as the exemplary fragmented 64 MB region. Each of the free lists 702 is associated with a memory size (e.g., p, 2p), and includes one or more nodes each specifying a partially free physical memory region having two times the associated memory size and having at least the associated amount of free space. For example, each node in the p free list specifies a partially free memory region having a total size of 2p and total free space that is at least p in size, and each node in the 2p free list specifies a partially free memory region having a total size of 4p and total free space that is at least 2p in size. A bit vector (e.g., bit vector 710) stored with each partially free physical memory region identifies the free physical subpages in the partially free physical memory region.

As an example, bit vector 710 identifies a subset of free physical subpages (corresponding to asserted bits) and a subset of already allocated physical subpages (corresponding to deasserted bits) in the partially free physical memory region 711. In the bit vector 710, the bits are arranged in the same order as their corresponding physical subpages in the physical memory region 711. As illustrated in FIG. 7, the bit vector 710 is stored with its associated physical memory region 711. In an alternative embodiment, a separate global bit vector is maintained, which tracks free subpages for multiple partially free physical memory regions.

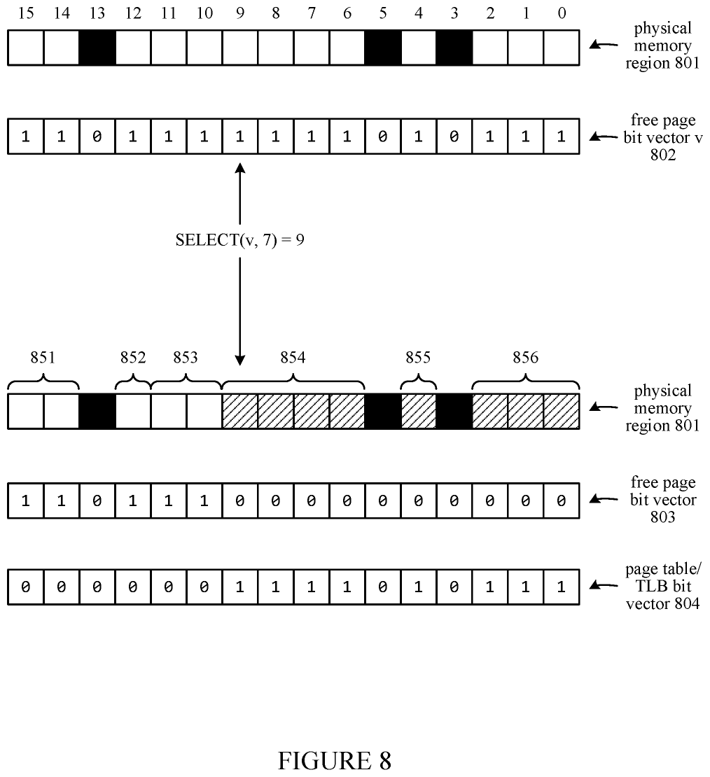

FIG. 8 illustrates the allocation of noncontiguous physical subpages in a physical memory region for backing a virtual superpage, according to an embodiment. The physical memory region 801 includes 16 physical subpages 0-15. Of these, subpages 3, 5, and 13 are already allocated. Accordingly, the free page bit vector 802 associated with the physical memory region 801 (or a segment of a global free page bit vector) includes deasserted bits at the positions 3, 5, and 13 corresponding to the already allocated subpages. The remaining bit positions in the bit vector 802 are asserted, indicating that their corresponding subpages are free.

In order to allocate a virtual superpage having 8 subpages, a SELECT operation is performed to identify a subset of 8 free subpages to allocate from the physical memory region 801. The SELECT operation takes the bit vector 802 and the index 7 (for counting 8 asserted bits) as inputs and outputs the index 9. In the physical memory region 801, the physical subpages up to and including index 9 (i.e., segments 854, 855, and 856) are allocated for backing the requested virtual superpage. The remaining unallocated subpages 851, 852, and 853 are moved to the free lists. Free segments 851 and 853 are moved to the 2p free list (for two-page contiguous free segments), and free segment 852 is moved to the p free list (for one-page free segments).

The free page bit vector 803 (or the segment of the global free page bit vector) is updated to deassert bits 0-2, 4, and 6-9 corresponding to the newly allocated subpages. A bit vector 804 is calculated by asserting the bits corresponding to the newly allocated physical subpages. The bit vector 804 is included in a page table entry for the newly allocated virtual superpage, and the page table entry is added to the page table 311. In one embodiment, the entry for the virtual superpage, including the bit vector 804, is also added to the TLB 311.

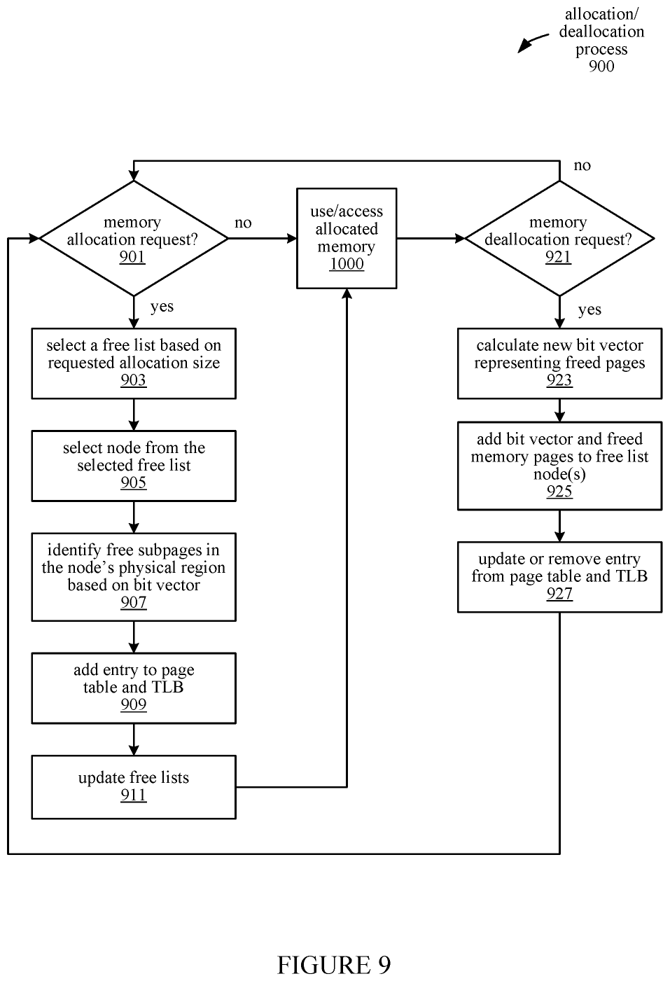

FIG. 9 illustrates a process 900 for allocating and deallocating memory in the computing system 200, according to an embodiment. The process 900 is performed by components in the computing system 200 (e.g., the processor 301 and MMU 302) to allocate physical memory in the main memory 206 to one or more virtual pages.

At block 901, if memory allocation is not requested, then no allocation is performed, and the system continues to use and access already allocated memory, as provided at block 1000. At block 901, if a memory allocation is requested, the operating system (executed by the processor 301) allocates physical memory from the main memory 206 according to blocks 903-911. At block 903, the operating system selects one of the free lists 312 based on the size of the memory to be allocated. Specifically, a free list is selected that includes physical memory regions that are greater than or equal to the requested allocation in size. In one embodiment, the size of the memory to be allocated is rounded up to the nearest size of a page times a power of two, and a free list that is associated with the resulting size is selected. In one embodiment, for a requested allocation size p, the selected free list has nodes each containing at least p free memory capacity and less than 2p free memory capacity, since 2p is the size associated with the next larger free list.

At block 905, the operating system selects one of the nodes from the set of nodes in the selected free list. If the selected free list is one of the contiguous free lists 701, then any of the physical memory subpages in the selected node can be used for the allocation. Any unallocated pages from the region are optionally moved to the free lists corresponding to their respective sizes.

In one embodiment, the allocation is filled using fragmented memory selected from one of the fragmented free lists 702. The free subpages in each of the node's partially free physical regions (e.g., region 711) are identified and selected for allocating for the virtual memory page based on the one or more bit vectors (e.g., bit vector 710) of the node, as provided at block 907. In particular, the operating system checks the one or more bit vectors associated with the partially free physical memory regions in the node to identify the free physical subpages in these regions. From the available free physical subpages, the operating system selects a sufficient number of free subpages for allocating to back the requested virtual page.

In one embodiment, the processor 301 facilitates this selection using an instruction that operates on the bit vector and returns a number of set bits equal to the number of virtual subpages in the virtual page. This instruction has two register operands: a first register containing the bit vector, and a second register for receiving the result of the computation. In one embodiment, the SELECT function is used to select the available free subpages for allocating to back the requested virtual page. For example, assuming 32 virtual subpages per virtual page, 64 physical subpages per physical region (e.g., 711), and one bit in the bit vector (e.g., 710) for each free physical subpage, the bit vector is 64 bits in length per physical region (e.g., 711). For each physical memory region (e.g., 711), each with an associated bit vector v (e.g., 710) that is 64 bits in length, the SELECT function is called with bit vector v and an index of 31 as inputs. The SELECT function returns the bit position index of the 31st bit that is set to ‘1’; this index is between 0 and 63 if valid, or 64 if invalid. The returned index represents the largest physical subpage number of the set of free physical subpages that will be allocated from the partially free physical memory region to back the virtual subpages in the requested virtual page.

At block 909, the operating system adds a page table entry to a leaf node 412 of the page table 311. Leaf node 412, child node 411, and root node 410 are created if they do not already exist, and entries are installed in each of these node levels that point to the appropriate node in the next level. The new page table entry in the leaf node 412 includes an address 422 and a bit vector 423, along with other metadata and AVAILABLE bits (not shown). Asserted bits in the bit vector 423 indicate that the physical subpage corresponding to the bit backs one of the virtual subpages in the page table entry's virtual page. In one embodiment, the bit vector 423 is generated by copying the bit vector 710 from the free list and masking the bits above the largest physical subpage number (i.e., the index calculated by the SELECT function, as previously described). The resulting bit vector contains an asserted bit for each physical subpage that is allocated for the virtual page number, and a deasserted bit for each physical subpage that is not allocated for the virtual page number. In some embodiments, since the virtual page number is newly allocated, it is likely to be accessed imminently; therefore, the new page table entry, including the bit vector 622, is also cached in the TLB 303. In an alternative embodiment, instead of (or in addition to) the bit vector, the mapping stored in the TLB entry includes precomputed physical subpage numbers associated with all (or some) of the virtual subpage numbers in the virtual page, as previously described with reference to FIGS. 6B and 6C.

At block 911, subpages in the physical memory region that remain unallocated are placed in a free list using the memory allocation system (e.g., a buddy or slab allocator). If fragmented free lists 702 are supported, then fragmented memory is placed in one of the fragmented free lists 702. For example, a 4 MB backing region having 3 MB of its memory allocated cannot back a 2 MB virtual page; however, the remaining 1 MB memory may be able to back several 256 KB virtual pages, assuming 256 KB is a supported page size. After the remaining free pages are added to a free list, the process 900 continues at block 1000. At block 1000, the requested allocation is complete, and the allocated memory is used to store application data. At block 921, if no memory deallocation is requested, the process 900 returns to block 901. Thus, blocks 901, 1000, and 921 are repeated while no memory is being allocated or deallocated.

At block 921, if memory deallocation is requested, the operating system frees one or more of the previously allocated physical subpages by performing the operations in blocks 923-927. At block 923, the operating system calculates a new bit vector to be recorded in one of the fragmented free lists 702 for the physical memory region containing the physical subpages being freed. Each bit in the new bit vector is asserted (e.g., ‘1’) if its corresponding subpage in the physical memory region is free or is being freed, or is deasserted (e.g., ‘0’) if the corresponding subpage will remain allocated. In one embodiment, a bit vector is calculated for each physical memory region containing physical subpages to be freed.

At block 925, the physical memory regions (e.g., region 711) containing the freed physical memory subpages are added to nodes in the appropriate fragmented free lists 702, along with their respective bit vectors (e.g., bit vector 710). For each physical memory region, a population count operation (which counts the number of bits set to 1) on the associated bit vector is used to determine the number of free physical subpages in the physical memory region. The operating system places several consecutive physical memory regions in a free list if the physical memory regions collectively have enough free capacity to allocate the granularity of request associated with that free list. For example, two consecutive physical memory regions each having size p (i.e., a total size of 2p) are placed together in a fragmented free list associated with size p if they collectively have at least p free memory capacity.

In some embodiments, the bit vectors for each of the partially allocated physical memory regions are stored separately with their respective physical memory regions in the free lists 702. In alternative embodiments, the bit vectors are merged into one or more larger bit vectors associated with larger regions of physical memory (e.g., consisting of multiple consecutive physical memory regions associated with the original bit vectors).

If buddy allocation is used, the operating system checks whether the freed memory (e.g., 32 MB of 16×4 MB regions, since only half is allocated) can be merged with its “buddy”, an equally sized set of adjacent physical memory regions (e.g., 16×4 MB). If both sets have at least half of their physical subpages free, they are merged into a single element and placed on the free list associated with the next higher power of two (e.g., 32×4 MB, where each entry allocates 64 MB of physical memory). This process repeats recursively up to the maximum allocation granularity size. Alternatively, freed physical subpages can be placed in one or more of the contiguous free lists 701. In this case, a set of contiguous free pages is divided into one or more segments each having a size that is a power of two times the page size. Each of the resulting segments is added to the free list associated with its size (e.g., a segment having size 2p is placed in the 2p free list).

At block 927, page table entries for virtual pages backed by the subpages being freed are updated or removed to reflect the deallocation. If one or more physical subpages will remain allocated to the virtual page, the bit vector in the page table entry is updated to deassert the bits corresponding to the freed subpages, while leaving the bits asserted that correspond to subpages remaining allocated. Page table entries for virtual pages that are no longer backed by any physical memory are removed from the page table and any corresponding TLB entries are invalidated.

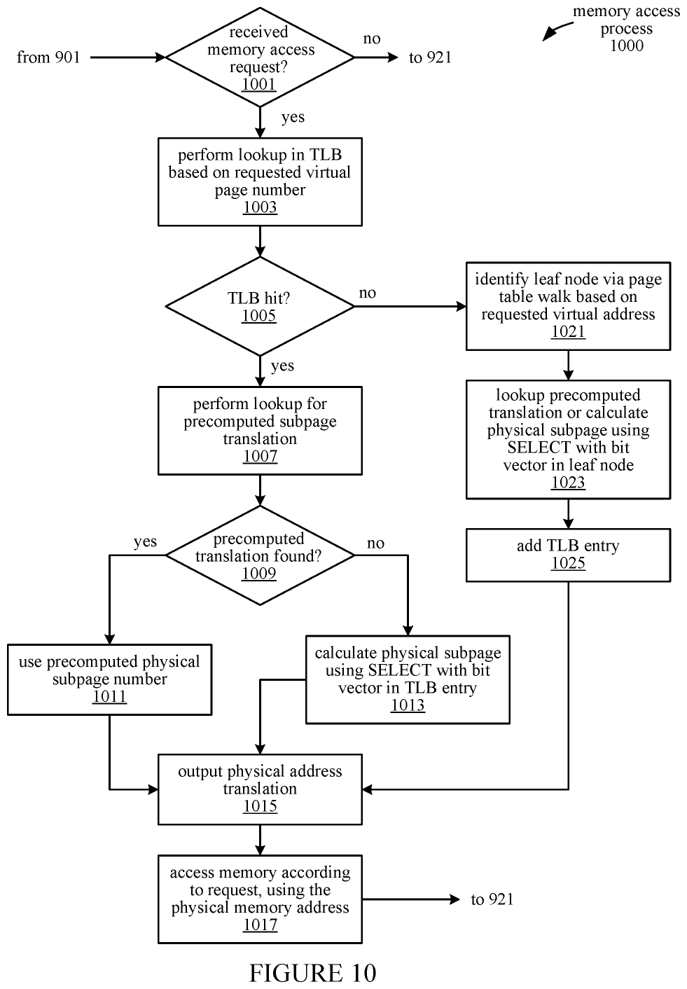

FIG. 10 illustrates a process 1000 for accessing allocated memory, according to an embodiment. Process 1000 corresponds to block 1000 in process 900. From block 901, if a memory access request (e.g., from a load or store instruction) is not received, the process 1000 continues to block 921 in process 900. Otherwise, if a memory access request is received, the process 1000 services the memory request according to blocks 1003-1017.

The received memory request specifies a virtual memory address 600 to be translated to a physical memory address 610 where data will be written or read. The processing unit 204 performs the memory translation using the TLB 303 if an entry for the virtual memory address is already cached in the TLB 303. Accordingly, memory access logic in the processing unit 204 performs a lookup in the TLB 303 based on the requested virtual page number 601 in the requested virtual address 600, as provided at block 1003. At block 1005, if the virtual page number 601 has an entry in the TLB 303, then the TLB lookup in block 1003 results in a hit, and the process 1000 continues at block 1007. At block 1007, the processor 204 performs a lookup for the virtual subpage number 602 in the precomputed translations field 624 of the matching TLB entry 650. In one embodiment, the processor 204 compares the virtual subpage number 602 with each of one or more speculated virtual subpage numbers (e.g., 625) in the precomputed translations field 624.

At block 1009, if the virtual subpage number 602 is found in the precomputed translations field 624, then the precomputed physical subpage number (e.g., 626) is read from the precomputed translations field 624 and is used as the physical subpage number 612 in the output physical memory address 610. If the SELECT circuit 631 is present, then the SELECT circuit 631 is bypassed and the SELECT operation is not performed. If the TLB entry does not include any precomputed translations field (as illustrated in FIG. 6A) or no translation has been precomputed for the virtual subpage number 602, then the process 1000 continues from block 1009 to block 1013.

At block 1013, the SELECT operation is performed by the SELECT circuit 631 to calculate the physical subpage number 612 based on the bit vector 622 in the TLB entry 650. The SELECT circuit 631 takes the bit vector 622 and the virtual subpage number 602 as inputs and determines the physical subpage number 612 by calculating an index of an ith least significant asserted bit in the bit vector 622, where i represents the requested virtual subpage number 602. The resulting index output from the SELECT circuit 631 is the physical subpage number 612, which identifies the physical subpage that is allocated for the requested virtual subpage number 602.

Once the physical subpage number 612 has been calculated according to either block 1011 or 1013, the process 1000 continues at block 1015. At block 1015, the TLB 303 outputs the physical memory address 610, including the physical region number 611 from the TLB entry 650, the precomputed or calculated physical subpage number 612, and the subpage offset 613 copied from the subpage offset 603 from the requested virtual memory address 600.

At block 1005, if a virtual memory address 400 is requested such that the TLB 303 does not contain an entry for the requested virtual page number 407, then a TLB miss occurs and the process 1000 continues at block 1021. At block 1021, a page table walk is performed, using the virtual page number 407 in the virtual memory address 400 to traverse the interior nodes (e.g., 411, 412) of the page table 311 until a leaf node 412 is reached. A mapping (e.g., a bit vector 423) in the leaf node 412 is used to calculate the physical subpage number, as provided at block 1023. In one embodiment, the SELECT function is performed using the bit vector 423 in the page table entry, similar to block 1013 in the TLB 303.

At block 1025, a TLB entry is created associating the requested virtual page number with the physical page number (combining the addresses 420, 421, and 422) determined from the page table walk. The bit vector 423 is copied from the page table entry to the new TLB entry. At block 1017, once the virtual memory address 600 has been translated to the physical memory address 610 (by the TLB 303 or the page table 311), the memory request accesses the memory 206 at the returned physical memory address 610 according to the original memory request. By the operation of the above processes 900 and 1000, the computing system 200 thus supports the allocation of fragmented noncontiguous memory for backing large virtual superpages.

A device includes an address translation buffer to, for each virtual page number of a plurality of virtual page numbers, store a mapping associated with the virtual page number. The mapping identifies a set of physical subpages allocated for the virtual page number, and the set of physical subpages includes at least a first physical subpage of a plurality of contiguous subpages in a physical memory region and excludes at least a second physical subpage of the plurality of contiguous subpages in the physical memory region. A memory management unit is coupled with the address translation buffer to, in response to receiving a requested virtual subpage number and a requested virtual page number of the plurality of virtual page numbers, determine, based on the mapping associated with the requested virtual page number, a physical subpage number identifying a physical subpage of the plurality of contiguous subpages that is allocated for the requested virtual subpage number.

In the device, for each virtual page number of the plurality of virtual page numbers, the mapping associated with the virtual page number includes a bit vector containing an asserted bit for each physical subpage of the plurality of contiguous physical subpages that is allocated for the virtual page number and a deasserted bit for each physical subpage in the physical memory region that is not allocated for the virtual page number.

The device also includes a SELECT circuit coupled with the address translation buffer to, for each virtual page number of the plurality of virtual page numbers, determine the physical subpage number by calculating an index of an ith least significant asserted bit in the bit vector, where i represents the requested virtual subpage number.

In the device, the address translation buffer is a translation lookaside buffer (TLB) that also includes, for each virtual page number of the plurality of virtual page numbers, a precomputed translation field that associates a speculated virtual subpage number with a precomputed physical subpage number identifying a physical subpage allocated for the speculated virtual subpage number.

The device also includes a SELECT circuit to, in response to receiving the requested virtual subpage number, compare the requested virtual subpage number with the speculated virtual subpage number. If the requested virtual subpage number matches the speculated virtual subpage number, the SELECT circuit determines the physical subpage number by reading the precomputed physical subpage number from the precomputed translation field. If the requested virtual subpage number does not match the speculated virtual subpage number, the SELECT circuit determines the physical subpage number by calculating the physical subpage number based on the mapping and the requested virtual subpage number.

In the device, the mapping includes a set of precomputed translations each associating a precomputed virtual subpage number with a precomputed physical subpage number.

The device also includes a free list coupled with the memory management unit. The free list contains a set of one or more nodes. Each node in the set of one or more nodes includes a bit vector and identifies a partially free physical memory region. The bit vector identifies a first subset of free subpages in the partially free physical memory region and a second subset of allocated subpages in the partially free physical memory region.

A method includes, for each virtual page number of a plurality of virtual page numbers, storing a mapping associated with the virtual page number. The mapping identifies a set of physical subpages allocated for the virtual page number. The set of physical subpages includes at least a first physical subpage of a plurality of contiguous subpages in a physical memory region and excludes at least a second physical subpage of the plurality of contiguous subpages in the physical memory region. The method also includes, in response to receiving a requested virtual subpage number and a requested virtual page number of the plurality of virtual page numbers, determining, based on the mapping associated with the requested virtual page number, a physical subpage number identifying a physical subpage of the plurality of contiguous subpages that is allocated for the requested virtual subpage number.

The method also includes, for each virtual page number of the plurality of virtual page numbers, recording the mapping associated with the virtual page number as a bit vector containing an asserted bit for each physical subpage of the plurality of contiguous physical subpages that is allocated for the virtual page number, and a deasserted bit for each physical subpage in the physical memory region that is not allocated for the virtual page number.

The method also includes, for each virtual page number of the plurality of virtual page numbers, determining the physical subpage number by calculating an index of an ith least significant asserted bit in the bit vector, where i represents the requested virtual subpage number.

The method also includes, for each virtual page number of the plurality of virtual page numbers, storing in a precomputed translation field of the address translation buffer a speculated virtual subpage number and precomputed physical subpage number identifying a physical subpage allocated for the speculated virtual subpage number.

The method also includes, in response to receiving the requested virtual subpage number, comparing the requested virtual subpage number with the speculated virtual subpage number and, if the requested virtual subpage number matches the speculated virtual subpage number, determining the physical subpage number by reading the precomputed physical subpage number from the precomputed translation field.

The method also includes storing a set of one or more nodes in a free list. Each node in the set of one or more nodes includes a bit vector and identifies a partially free physical memory region. The bit vector identifies a first subset of free subpages in the partially free physical memory region and a second subset of allocated subpages in the partially free physical memory region. The method also includes, in response to a request to allocate physical memory, selecting a first node from the set of one or more nodes in the free list. The free list is associated with a size p that is greater than a memory size of the request. The partially free physical memory region identified in the selected first node contains at least p free memory capacity.

The method also includes freeing one or more subpages of the set of physical subpages by calculating a bit vector for the physical memory region. Each bit in the bit vector indicates whether a corresponding subpage in the physical memory region is free. The method also includes adding a new node to the first free list. The new node contains the calculated bit vector and identifies the physical memory region.

The method also includes, for each virtual page number of the plurality of virtual page numbers, prior to storing the mapping associated with the virtual page number and in response to a translation lookaside buffer (TLB) miss, traversing a page table based on the virtual page number to identify the mapping in the page table. The mapping is stored in the page table as a bit vector. The method also includes storing the mapping by copying the mapping from the page table to the TLB.

A computing system, includes a main memory containing a physical memory region, a processor coupled with the main memory, and an address translation buffer to, for each virtual page number of a plurality of virtual page numbers, store a mapping associated with the virtual page number. The mapping identifies a set of physical subpages allocated for the virtual page number. The set of physical subpages includes at least a first physical subpage of a plurality of contiguous subpages in the physical memory region and excludes at least a second physical subpage of the plurality of contiguous subpages in the physical memory region. The computing system also includes a memory management unit coupled with the processor and the address translation buffer to, in response to receiving a requested virtual subpage number and a requested virtual page number of the plurality of virtual page numbers, determine, based on the mapping associated with the requested virtual page number, a physical subpage number identifying a physical subpage of the plurality of contiguous subpages that is allocated for the requested virtual subpage number.

In the computing system, for each virtual page number of the plurality of virtual page numbers, the mapping associated with the virtual page number includes a bit vector containing an asserted bit for each physical subpage of the plurality of contiguous physical subpages that is allocated for the virtual page number, and a deasserted bit for each free subpage in the physical memory region that is not allocated for the virtual page number. The computing system also includes a SELECT circuit coupled with the address translation buffer. The SELECT circuit determines the physical subpage number by calculating an index of an ith least significant asserted bit in the bit vector, wherein i represents the requested virtual subpage number.

In the computing system, the address translation buffer also includes, for each virtual page number of the plurality of virtual page numbers, a precomputed translation field to associate a speculated virtual subpage number with a precomputed physical subpage number identifying a physical subpage allocated for the speculated virtual subpage number. The computing system also includes a SELECT circuit to compare the requested virtual subpage number with the speculated virtual subpage number. If the requested virtual subpage number matches the speculated virtual subpage number, the SELECT circuit determines the physical subpage number by reading the precomputed physical subpage number from the precomputed translation field. If the requested virtual subpage number does not match the speculated virtual subpage number, the SELECT circuit determines the physical subpage number by calculating the physical subpage number based on the mapping and the requested virtual subpage number.

The computing system also includes a free list coupled with the processor to store a set of one or more nodes. Each node in the set of one or more nodes includes a bit vector and identifies a partially free physical memory region. The bit vector identifies a first subset of free subpages in the partially free physical memory region and a second subset of allocated subpages in the partially free physical memory region. The processor also allocates physical memory from the main memory for a virtual memory page by selecting the free list based on a size of the virtual memory page and based on a size p associated with the free list, selecting a first node from the set of one or more nodes in the free list, and based on the bit vector in the selected first node, selecting the set of physical subpages for allocating for the virtual memory page. The partially free physical memory region identified in the selected first node contains at least p free memory capacity.

In the computing system, the processor also frees one or more subpages of the set of physical subpages by calculating a bit vector for the physical memory region, and adding a new node to a free list. Each bit in the bit vector indicates whether a corresponding subpage in the physical memory region is free, and the new node contains the calculated bit vector and identifies the physical memory region.

As used herein, the term “coupled to” may mean coupled directly or indirectly through one or more intervening components. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Certain embodiments may be implemented as a computer program product that may include instructions stored on a non-transitory computer-readable medium. These instructions may be used to program a general-purpose or special-purpose processor to perform the described operations. A computer-readable medium includes any mechanism for storing or transmitting information in a form (e.g., software, processing application) readable by a machine (e.g., a computer). The non-transitory computer-readable storage medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory, or another type of medium suitable for storing electronic instructions.

Additionally, some embodiments may be practiced in distributed computing environments where the computer-readable medium is stored on and/or executed by more than one computer system. In addition, the information transferred between computer systems may either be pulled or pushed across the transmission medium connecting the computer systems.

Generally, a data structure representing the computing system 200 and/or portions thereof carried on the computer-readable storage medium may be a database or other data structure which can be read by a program and used, directly or indirectly, to fabricate the hardware including the computing system 200. For example, the data structure may be a behavioral-level description or register-transfer level (RTL) description of the hardware functionality in a high level design language (HDL) such as Verilog or VHDL. The description may be read by a synthesis tool which may synthesize the description to produce a netlist including a list of gates from a synthesis library. The netlist includes a set of gates which also represent the functionality of the hardware including the computing system 200. The netlist may then be placed and routed to produce a data set describing geometric shapes to be applied to masks. The masks may then be used in various semiconductor fabrication steps to produce a semiconductor circuit or circuits corresponding to the computing system 200. Alternatively, the database on the computer-readable storage medium may be the netlist (with or without the synthesis library) or the data set, as desired, or Graphic Data System (GDS) II data.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be in an intermittent and/or alternating manner.

In the foregoing specification, the embodiments have been described with reference to specific exemplary embodiments thereof. It will, however, be evident that various modifications and changes may be made thereto without departing from the broader scope of the embodiments as set forth in the appended claims. The specification and drawings are, accordingly, to be regarded in an illustrative sense rather than a restrictive sense.

1. A device, comprising:
an address translation buffer configured to, for each virtual page number of a plurality of virtual page numbers, store a mapping associated with the virtual page number, wherein
the mapping identifies a set of physical subpages allocated for the virtual page number, and
the set of physical subpages includes at least a first physical subpage of a plurality of contiguous subpages in a physical memory region and excludes at least a second physical subpage of the plurality of contiguous subpages in the physical memory region; and
a memory management unit coupled with the address translation buffer, wherein the memory management unit is configured to,
in response to receiving a requested virtual subpage number and a requested virtual page number of the plurality of virtual page numbers,
determine, based on the mapping associated with the requested virtual page number, a physical subpage number identifying a physical subpage of the plurality of contiguous subpages that is allocated for the requested virtual subpage number.

2. The device of claim 1, wherein for each virtual page number of the plurality of virtual page numbers, the mapping associated with the virtual page number comprises a bit vector containing:
an asserted bit for each physical subpage of the plurality of contiguous physical subpages that is allocated for the virtual page number; and
a deasserted bit for each physical subpage in the physical memory region that is not allocated for the virtual page number.

3. The device of claim 1, further comprising a SELECT circuit coupled with the address translation buffer, wherein the SELECT circuit is configured to, for each virtual page number of the plurality of virtual page numbers, determine the physical subpage number by calculating an index of an ith least significant asserted bit in the bit vector, wherein i represents the requested virtual subpage number.

4. The device of claim 1, wherein the address translation buffer is a translation lookaside buffer (TLB) and further comprises, for each virtual page number of the plurality of virtual page numbers, a precomputed translation field configured to associate a speculated virtual subpage number with a precomputed physical subpage number identifying a physical subpage allocated for the speculated virtual subpage number.

5. The device of claim 1, further comprising a SELECT circuit configured to, in response to receiving the requested virtual subpage number:
compare the requested virtual subpage number with the speculated virtual subpage number;
if the requested virtual subpage number matches the speculated virtual subpage number, determine the physical subpage number by reading the precomputed physical subpage number from the precomputed translation field; and
if the requested virtual subpage number does not match the speculated virtual subpage number, determine the physical subpage number by calculating the physical subpage number based on the mapping and the requested virtual subpage number.

6. The device of claim 1, wherein the mapping comprises a set of precomputed translations each associating a precomputed virtual subpage number with a precomputed physical subpage number.

7. The device of claim 1, further comprising:
a free list coupled with the memory management unit, wherein:
the free list contains a set of one or more nodes,
each node in the set of one or more nodes includes a bit vector and identifies a partially free physical memory region, and
the bit vector identifies a first subset of free subpages in the partially free physical memory region and a second subset of allocated subpages in the partially free physical memory region.

8. A method, comprising:
for each virtual page number of a plurality of virtual page numbers, storing a mapping associated with the virtual page number, wherein
the mapping identifies a set of physical subpages allocated for the virtual page number, and
the set of physical subpages includes at least a first physical subpage of a plurality of contiguous subpages in a physical memory region and excludes at least a second physical subpage of the plurality of contiguous subpages in the physical memory region; and
in response to receiving a requested virtual subpage number and a requested virtual page number of the plurality of virtual page numbers, determining, based on the mapping associated with the requested virtual page number, a physical subpage number identifying a physical subpage of the plurality of contiguous subpages that is allocated for the requested virtual subpage number.

9. The method of claim 8, further comprising:
for each virtual page number of the plurality of virtual page numbers, recording the mapping associated with the virtual page number as a bit vector containing:
an asserted bit for each physical subpage of the plurality of contiguous physical subpages that is allocated for the virtual page number; and
a deasserted bit for each physical subpage in the physical memory region that is not allocated for the virtual page number.

10. The method of claim 9, further comprising, for each virtual page number of the plurality of virtual page numbers, determining the physical subpage number by calculating an index of an ith least significant asserted bit in the bit vector, wherein i represents the requested virtual subpage number.

11. The method of claim 8, further comprising, for each virtual page number of the plurality of virtual page numbers, storing in a precomputed translation field of the address translation buffer a speculated virtual subpage number and precomputed physical subpage number identifying a physical subpage allocated for the speculated virtual subpage number.

12. The method of claim 11, further comprising, in response to receiving the requested virtual subpage number:
comparing the requested virtual subpage number with the speculated virtual subpage number; and
if the requested virtual subpage number matches the speculated virtual subpage number, determining the physical subpage number by reading the precomputed physical subpage number from the precomputed translation field.

13. The method of claim 8, further comprising:
storing a set of one or more nodes in a free list, wherein
each node in the set of one or more nodes includes a bit vector and identifies a partially free physical memory region, and
the bit vector identifies a first subset of free subpages in the partially free physical memory region and a second subset of allocated subpages in the partially free physical memory region; and
in response to a request to allocate physical memory, selecting a first node from the set of one or more nodes in the free list, wherein
the free list is associated with a size p that is greater than a memory size of the request, and
the partially free physical memory region identified in the selected first node contains free memory capacity that is at least p in size.

14. The method of claim 8, further comprising freeing one or more subpages of the set of physical subpages by:
calculating a bit vector for the physical memory region, wherein each bit in the bit vector indicates whether a corresponding subpage in the physical memory region is free; and
adding a new node to the first free list, wherein the new node contains the calculated bit vector and identifies the physical memory region.

15. The method of claim 8, further comprising, for each virtual page number of the plurality of virtual page numbers:
prior to storing the mapping associated with the virtual page number and in response to a translation lookaside buffer (TLB) miss, traversing a page table based on the virtual page number to identify the mapping in the page table, wherein the mapping is stored in the page table as a bit vector; and
storing the mapping by copying the mapping from the page table to the TLB.

16. A computing system, comprising:
a main memory containing a physical memory region;
a processor coupled with the main memory;
an address translation buffer configured to, for each virtual page number of a plurality of virtual page numbers, store a mapping associated with the virtual page number, wherein
the mapping identifies a set of physical subpages allocated for the virtual page number, and
the set of physical subpages includes at least a first physical subpage of a plurality of contiguous subpages in the physical memory region and excludes at least a second physical subpage of the plurality of contiguous subpages in the physical memory region; and
a memory management unit coupled with the processor and the address translation buffer, wherein the memory management unit is configured to,
in response to receiving a requested virtual subpage number and a requested virtual page number of the plurality of virtual page numbers, determine, based on the mapping associated with the requested virtual page number, a physical subpage number identifying a physical subpage of the plurality of contiguous subpages that is allocated for the requested virtual subpage number.

17. The computing system of claim 16, wherein:
for each virtual page number of the plurality of virtual page numbers, the mapping associated with the virtual page number comprises a bit vector containing:
an asserted bit for each physical subpage of the plurality of contiguous physical subpages that is allocated for the virtual page number, and
a deasserted bit for each free subpage in the physical memory region that is not allocated for the virtual page number;
the computing system further comprises a SELECT circuit coupled with the address translation buffer; and
the SELECT circuit is configured to determine the physical subpage number by calculating an index of an ith least significant asserted bit in the bit vector, wherein i represents the requested virtual subpage number.

18. The computing system of claim 16, wherein:
the address translation buffer further comprises, for each virtual page number of the plurality of virtual page numbers, a precomputed translation field configured to associate a speculated virtual subpage number with a precomputed physical subpage number identifying a physical subpage allocated for the speculated virtual subpage number;
the computing system further comprises a SELECT circuit configured to:
compare the requested virtual subpage number with the speculated virtual subpage number;
if the requested virtual subpage number matches the speculated virtual subpage number, determine the physical subpage number by reading the precomputed physical subpage number from the precomputed translation field; and
if the requested virtual subpage number does not match the speculated virtual subpage number, determine the physical subpage number by calculating the physical subpage number based on the mapping and the requested virtual subpage number.

19. The computing system of claim 16, further comprising:
a free list coupled with the processor and configured to store a set of one or more nodes, wherein:
each node in the set of one or more nodes includes a bit vector and identifies a partially free physical memory region,
the bit vector identifies a first subset of free subpages in the partially free physical memory region and a second subset of allocated subpages in the partially free physical memory region,
the processor is further configured to allocate physical memory from the main memory for a virtual memory page by:
selecting the free list based on a size of the virtual memory page and based on a size p associated with the free list;
selecting a first node from the set of one or more nodes in the free list; and
based on the bit vector in the selected first node, selecting the set of physical subpages for allocating for the virtual memory page, wherein the partially free physical memory region identified in the selected first node contains free memory capacity that is at least p in size.

20. The computing system of claim 16, wherein the processor is further configured to free one or more subpages of the set of physical subpages by:
calculating a bit vector for the physical memory region, wherein each bit in the bit vector indicates whether a corresponding subpage in the physical memory region is free; and
adding a new node to a free list, wherein the new node contains the calculated bit vector and identifies the physical memory region.
